(19) United States
(12) Patent Application Publication
(10) Pub. No.: US 2023/0059541 A1
(43) Pub. Date: Feb. 23, 2023

(54) IMMERSION TYPE BATTERY COOLING SYSTEM INCLUDING VORTEX GENERATOR

(71) Applicant: HYUNDAI MOBIS Co., Ltd., Seoul (KR)

(72) Inventor: Young Chan YOON, Yongin-si (KR)

(73) Assignee: HYUNDAI MOBIS Co., Ltd., Seoul (KR)

(21) Appl. No.: 17/882,125

(22) Filed: Aug. 5, 2022

(30) Foreign Application Priority Data
Aug. 20, 2021 (KR) 10-2021-0110485

(51) Int. Cl. H01M 10/6551; H01M 10/613; H01M 10/6567; H01M 10/6556; H01M 10/625

(52) U.S. Cl. CPC H01M 10/6551; H01M 10/613; H01M 10/625; H01M 10/6556; H01M 10/6567; H01M 2220/20

(57) ABSTRACT

An immersion type battery cooling system includes a cooling block configured to accommodate a cooling fluid flowable within the cooling block, and a battery accommodated within the cooling block. The cooling block has a vortex generator, formed on an inner wall of the cooling block, configured to protrude towards the battery.

### CROSS-REFERENCE TO RELATED APPLICATION

This application claims the benefit under 35 USC 119(a) of Korean Patent Application No. 10-2021-0110485, filed on Aug. 20, 2021, the entire disclosure of which is incorporated herein by reference for all purposes.

### BACKGROUND

### 1. Field

The following description relates to an immersion type battery cooling system, and more specifically, to an immersion type battery cooling system, which brings a cooling fluid into direct contact with a battery and includes a vortex generation structure inside a cooling block, thereby improving cooling performance of a battery for an electric vehicle.

### 2. Discussion of Related Art

Vehicles currently use fossil energy such as petroleum as a power source, but since the fossil energy reserves are gradually decreasing and cause environmental pollution due to exhaust gases, electric vehicles using electricity as a power source are being developed.

A structure of the battery used in electric vehicles is typically composed of a plurality of battery cells composed of a lithium ion secondary battery or the like, a battery module to which the plurality of battery cells are connected, and a plate-shaped battery pack in which the battery modules are connected in series and/or in parallel.

Since the battery module generates heat upon charging or discharging, in the electric vehicles, a battery cooling device is typically configured along with the battery, and the battery cooling device has a structure in which a cooling fluid may flow. The cooling fluid absorbs the heat emitted by the battery module to adjust a temperature of the battery module.

FIG. 1 is a view showing a conventional battery cooling system. Referring to FIG. 1, the conventional battery cooling system is configured in the form of positioning a cooling block at the bottom of a pouch-type battery pack in which a plurality of battery cells are stacked to absorb the heat of the battery pack at the top.

Here, since a contact area between the battery pack and the cooling block is limited to an area of a bottom surface of the battery pack, cooling efficiency of the battery pack is not good. In order to respond to a high density of electric vehicle batteries and an increase in the amount of heat generated through continuous R&D in the future, it is necessary to introduce a cooling system with a structure capable of improving the cooling efficiency of the battery pack.

In addition, in the conventional battery cooling system, there may occur a problem that cooling is performed from the bottom surface, and thus a temperature deviation within the battery cell increases due to a low thermal conductivity of the battery cell. This temperature deviation within the battery cell may lead to a problem of reducing the charging and discharging efficiency of the battery.

Accordingly, it is necessary to develop a battery cooling system, which solves the above-described problem and exhibits sufficient cooling performance by designing a structure of a cooling system in which the battery and the cooling fluid come into direct contact with each other to cool the battery.

### Related Art Documents

### Patent Documents

[Patent Document 1] Korean Pat. No. 10-2269252

[Patent Document 2] Korean Pat. No. 10-2269290

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an immersion type battery cooling system includes a cooling block configured to accommodate a cooling fluid flowable within the cooling block, and a battery accommodated within the cooling block. The cooling block has a vortex generator, formed on an inner wall of the cooling block, configured to protrude towards the battery.

The cooling block may include an inlet through which the cooling fluid is introduced, and an outlet through which the cooling fluid is discharged.

The vortex generator may be spaced apart from the battery by a first distance, and the cooling fluid flows between the vortex generator and the battery.

The first distance between the vortex generator and the battery may be ½ or more of a second distance between the inner wall of the cooling block and the battery.

The first distance between the vortex generator and the battery may be 3 mm or more.

The vortex generator may include a plurality of vortex generators each spaced apart from another by a first interval. A ratio of a length of the battery and the first interval may be configured to be 0.1 or more.

The battery may be formed by stacking a plurality of cells.

The battery may be configured to have any one of a cylindrical shape, a prismatic shape, and a pouch shape.

In another general aspect, an immersion type battery cooling system includes a cooling block configured to accommodate a cooling fluid flowable within the cooling block, a battery accommodated within the cooling block, and a vortex generator fixed to an inner wall of the cooling block. The cooling fluid may directly contact the battery within the cooling block.

The vortex generator may include a plurality of vortex generators, disposed on upper and lower inner walls of the cooling block, spaced apart from the battery by a first distance.

The cooling fluid may absorb heat emitted by the battery through direct contact.

The cooling fluid may have insulating property.

In another general aspect, a vortex generator includes a plate extending in a first direction, and a plurality of protrusions formed on one surface of the plate. The protrusions are formed to be spaced apart from another by a first distance in the first direction.

The protrusions may be formed in columns with top surfaces integrated with the plate.

The columns may have either a triangular or sectorial cross section.

An immersion type battery cooling system includes a cooling block configured to accommodate a cooling fluid flowable within the cooling block, wherein the cooling block comprises the vortex generator above; and a battery accommodated within the cooling block.

Other features and aspects will be apparent from the following detailed description, the drawings, and the claims.

### BRIEF DESCRIPTION OF THE DRAWINGS

FIG. 1 is a view showing a structure of a conventional battery cooling system.

FIGS. 2A and 2B are an exploded view and a cross-sectional view showing a configuration of an immersion type battery cooling system according to one embodiment of the present disclosure, respectively.

FIGS. 3A and 3B are views showing the flow of a cooling fluid of the immersion type battery cooling system according to one embodiment of the present disclosure and a temperature for each zone according to the flow of the cooling fluid, respectively.

FIG. 4 is a view showing a structure of a vortex generator according to one embodiment of the present disclosure.

FIGS. 5A to 5D are views showing various embodiments of the vortex generator according to the present disclosure.

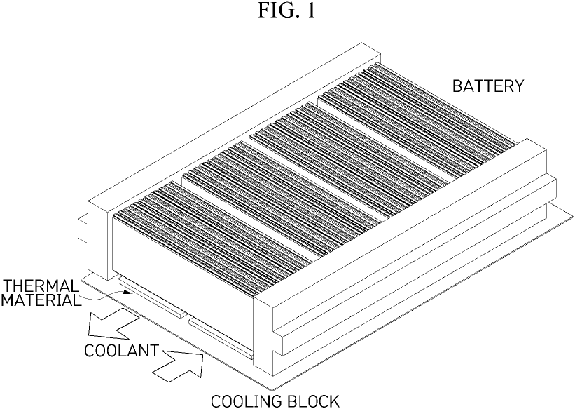

Throughout the drawings and the detailed description, the same reference numerals refer to the same or like elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

### Immersion Type Battery Cooling System

The present disclosure is directed to providing an immersion type battery cooling system with improved battery cooling performance through a direct cooling method in which a battery and a cooling fluid come into direct contact with each other.

In addition, the present disclosure is directed to providing an immersion type battery cooling system in which a heat transfer coefficient is improved by changing the flow characteristics of a cooling fluid through a vortex generator formed on an inner wall of a cooling block.

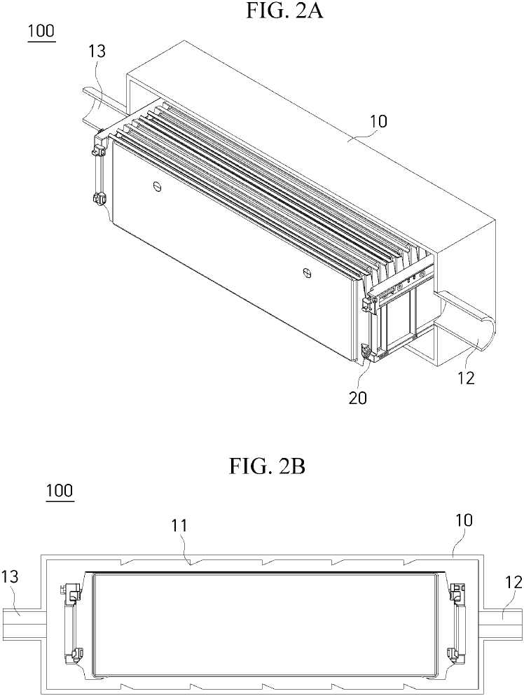

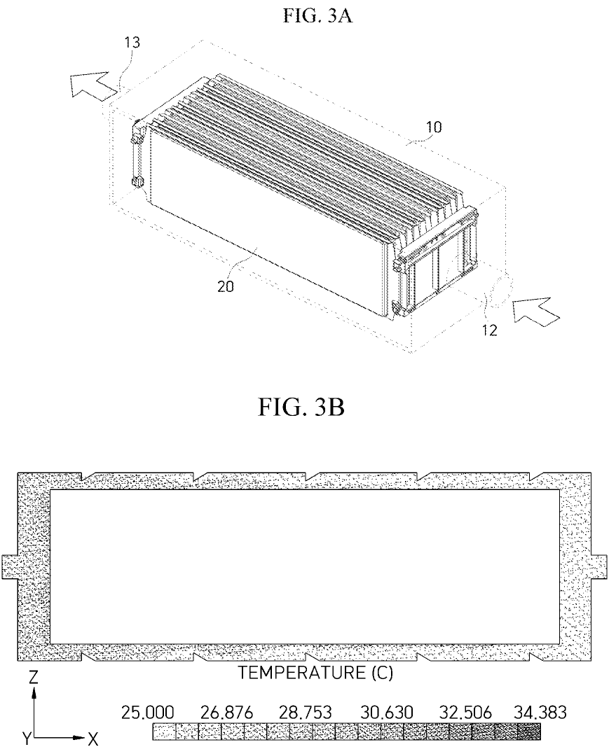

FIG. 2A is an exploded view showing a configuration of an immersion type battery cooling system 100 according to one embodiment of the present disclosure, FIG. 2B is a cross-sectional view showing a configuration of the immersion type battery cooling system 100 according to one embodiment of the present disclosure, FIG. 3A is a perspective view showing a drive method of the immersion type battery cooling system 100 according to one embodiment of the present disclosure, and FIG. 3B is a cross-sectional view showing a temperature for each zone according to the flow of the cooling fluid according to one embodiment of the present disclosure. Referring to FIGS. 2A and 2B and FIGS. 3A and 3B, the immersion type battery cooling system 100 is largely composed of a cooling block 10 and a battery 20, and the cooling block 10 includes a vortex generator 11, an inlet 12, and an outlet 13. A description of each configuration and detailed configuration is as follows.

The cooling block 10 may be configured as a housing having a cylindrical structure. Here, the cooling block 10 may accommodate the battery 20 therein and may be configured as a housing provided with a space in which a cooling fluid may move. For example, the cooling block 10 may be configured in a cylindrical structure having a cross section of a polygon such as a rectangle or a pentagon, or a circle

Meanwhile, the shape of the cooling block 10 according to one embodiment of the present disclosure is presented and described as a rectangular parallelepiped shape, but it should be understood that this is not intended to limit the scope of the present disclosure, and as described above, a housing structure provided with the space in which the battery 20 is accommodated and the cooling fluid may flow corresponds to the cooling block 10 of the present disclosure.

In one embodiment, the cooling block 10 may be formed with the inlet 12 and the outlet 13 through which the cooling fluid passes. The inlet 12 and the outlet 13 may be configured in the form of an opening with a certain size and are formed on surfaces facing each other so that the cooling fluid may circulate inside the cooling block 10 and may be discharged therefrom.

In one embodiment, the cooling block 10 may have the vortex generator 11 formed on the inner wall. Here, the vortex generator 11 serves to generate a vortex of the cooling fluid in order to change the flow characteristics of the cooling fluid that flows inside the cooling block 10. In order to perform this role, the vortex generator 11 may be configured in the form of protruding from the inner wall of the cooling block 10 in a certain size and shape. Referring to FIG. 3B, it may be confirmed that a heat boundary layer generated by the cooling fluid absorbing the heat of the battery 20 while the cooling fluid moves inside the cooling block 10 is periodically destroyed by the vortex generator 11. Here, the heat boundary layer is generated by a temperature change of the cooling fluid between the inner walls of the cooling block 10 in the battery 20, and the development of the heat boundary layer is a factor that degrades the cooling performance of the battery 20. Accordingly, the vortex generator 11 can periodically destroy the heat boundary layer, thereby improving the cooling efficiency of the battery 20.

In one embodiment, the vortex generator 11 may be located at the top and bottom of the battery 20 with respect to a direction in which the cooling fluid moves within the cooling block 10. Here, the vortex generator 11 may be fixed to the inner wall of the cooling block 10 in an integrated or coupled form.

In one embodiment, the vortex generator 11 may be formed in a state of being spaced apart from the battery 20 accommodated inside the cooling block 10 by a certain distance h, so that the cooling fluid may move between the vortex generator 11 and the battery 20. Here, the certain distance h, that is, the distance h between the vortex generator 11 and the battery 20 means a straight distance from an end of the vortex generator 11 to a surface of the battery 20.

In one embodiment, the distance h between the vortex generator 11 and the battery 20 may be formed to be ½ or more of a distance H between the inner wall of the cooling block 10 and the battery 20. In other words, the vortex generator 11 may protrude by a size of less than ½ of the distance H between the inner wall of the cooling block 10 and the battery 20. Specifically, the distance h between the vortex generator 11 and the battery 20 may be formed to be 3 mm or more.

Here, when the vortex generator 11 excessively protrudes and thus the distance h between the vortex generator 11 and the battery 20 is excessively short, less than 3 mm, the excessive pressure drop of the cooling fluid passing through between the vortex generator 11 and the battery 20 may occur to reduce a flow rate of the cooling fluid, and degrading the cooling efficiency of the immersion type battery cooling system 100.

In one embodiment, a plurality of vortex generators 11 are configured and may be formed on the inner wall of the cooling block 10 in a state of being spaced apart from each other by a certain interval d, and a ratio (d/L) between an entire length L of the battery 20 and the interval d between the vortex generators 11 may be configured to be 0.1 or more. Here, when the plurality of vortex generators 11 are formed at an excessively short interval so that the ratio (d/L) is less than 0.1, since the effect of changing the flow characteristics of the cooling fluid may be insignificant, the plurality of vortex generators 11 may be formed to be spaced apart from each other so that the ratio (d/L) is 0.1 or more.

The battery 20 may be configured as a lithium ion battery generally used in electric vehicles. Here, the battery 20 may be formed by stacking a plurality of cells, and configured in any one of a cylindrical shape, a prismatic shape, and a pouch shape.

In one embodiment, it should be noted that the battery 20 may be accommodated in the cooling block 10, it is sufficient when the battery 20 may be accommodated in the cooling block 10, and the shape of the battery cell 20 is not limited to a special configuration.

In one embodiment, the battery 20 may come into direct contact with the cooling fluid inside the cooling block 10, so that the heat emitted from the battery 20 may be cooled. Here, the cooling fluid may be made of a fluid having an insulating property because it comes into direct contact with the battery 20, thereby preventing damage to the battery 20.

### Vortex Generator

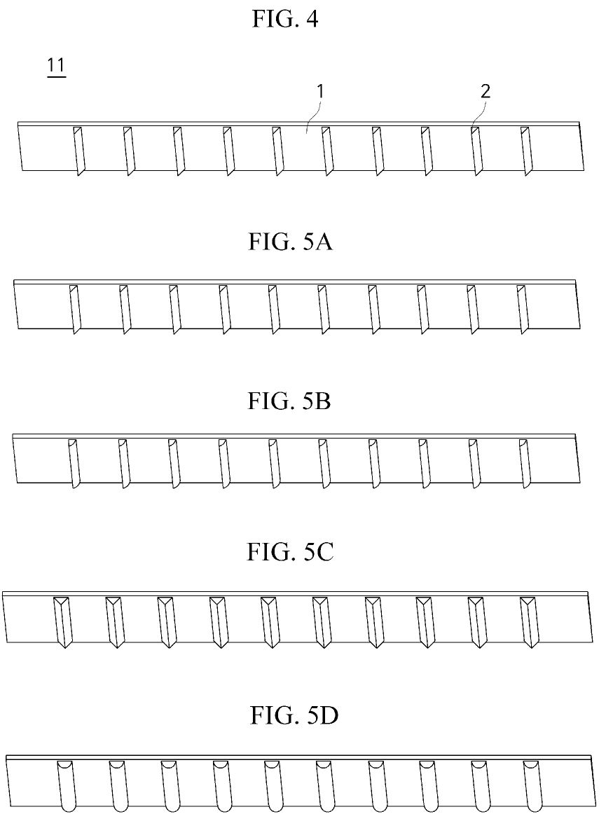

FIG. 4 is a view showing a structure of the vortex generator 11 according to one embodiment of the present disclosure, and FIGS. 5A to 5D are views showing various embodiments of the vortex generator 11 according to the present disclosure. Referring to FIG. 4, and FIGS. 5A to 5D, the vortex generator 11 is composed of a plate 1 and a protrusion 2. A description of each configuration is as follows.

The plate 1 is a flat plate extending in a certain direction. In one embodiment, a surface of the plate 1 may be formed in a smooth state so that there is no resistance to the flow of the fluid because the plate 1 may come into contact with various fluids such as the cooling fluid. In addition, the plate 1 may be made of a material having non-reactive characteristics with the fluid so that damage due to the fluid does not occur.

The protrusion 2 serves to generate a vortex by changing the flow characteristics of the fluid flowing to one side of the plate 1. In order to perform this role, the protrusion 2 may be formed on one surface of the plate 1, and configured in the form of a column integrated with the plate 1. Specifically, the protrusion 2 has one surface that comes into surface contact with the fluid flowing in a certain direction, and the fluid coming into surface contact with the protrusion 2 flows along the surface of the protrusion 2 and thus a flow velocity becomes slower than that of the fluid not going through the protrusion 2, so that a flow rate for each zone of the entire fluid may be changed.

In one embodiment, the protrusion 2 may be formed in the form of a column having a cross section of any one of a polygonal shape, such as a triangle or a quadrangle, a circular shape, and a sector shape. Referring to of FIGS. 5A to 5D, the protrusion 2 may be configured in the form of a column of various shapes according to an interior angle of a figure configuring a cross section. For example, when the protrusion 2 is configured as a triangular column having a triangular cross section, the degree of sharpness of the protrusion 2 may be adjusted depending on the interior angle of the cross-sectional triangle corresponding to the location of the end thereof. In addition, when the protrusion 2 is configured as a cylinder having a sectoral cross section, a size of the cross-sectional area coming into contact with the fluid may be adjusted depending on the interior angle of the sectoral cross section.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An immersion type battery cooling system, comprising:
a cooling block configured to accommodate a cooling fluid flowable within the cooling block; and
a battery accommodated within the cooling block,
wherein the cooling block has a vortex generator, formed on an inner wall of the cooling block, configured to protrude towards the battery.

2. The immersion type battery cooling system of claim 1, wherein the cooling block comprises an inlet through which the cooling fluid is introduced, and an outlet through which the cooling fluid is discharged.

3. The immersion type battery cooling system of claim 1, wherein the vortex generator is spaced apart from the battery by a first distance, and the cooling fluid flows between the vortex generator and the battery.

4. The immersion type battery cooling system of claim 3, wherein the first distance between the vortex generator and the battery is ½ or more of a second distance between the inner wall of the cooling block and the battery.

5. The immersion type battery cooling system of claim 3, wherein the first distance between the vortex generator and the battery is 3 mm or more.

6. The immersion type battery cooling system of claim 1, wherein the vortex generator comprises a plurality of vortex generators each spaced apart from another by a first interval, and
a ratio of a length of the battery and the first interval is configured to be 0.1 or more.

7. The immersion type battery cooling system of claim 1, wherein the battery is formed by stacking a plurality of cells.

8. The immersion type battery cooling system of claim 1, wherein the battery is configured to have any one of a cylindrical shape, a prismatic shape, and a pouch shape.

9. An immersion type battery cooling system, comprising:
a cooling block configured to accommodate a cooling fluid flowable within the cooling block;
a battery accommodated within the cooling block; and
a vortex generator fixed to an inner wall of the cooling block,
wherein the cooling fluid directly contacts the battery within the cooling block.

10. The immersion type battery cooling system of claim 9, wherein the vortex generator comprises a plurality of vortex generators, disposed on upper and lower inner walls of the cooling block, spaced apart from the battery by a first distance.

11. The immersion type battery cooling system of claim 9, wherein the cooling fluid absorbs heat emitted by the battery through direct contact.

12. The immersion type battery cooling system of claim 9, wherein the cooling fluid has insulating property.

13. A vortex generator, comprising:
a plate extending in a first direction; and
a plurality of protrusions formed on one surface of the plate,
wherein the protrusions are formed to be spaced apart from another by a first distance in the first direction.

14. The vortex generator of claim 13, wherein the protrusions are formed in columns with top surfaces integrated with the plate.

15. The vortex generator of claim 14, wherein the columns have either a triangular or sectorial cross section.

16. An immersion type battery cooling system, comprising:
a cooling block configured to accommodate a cooling fluid flowable within the cooling block, wherein the cooling block comprises the vortex generator of claim 14; and
a battery accommodated within the cooling block.
